(19) United States
(12) Patent Application Publication
(10) Pub. No.: US 2024/0183454 A1
(43) Pub. Date: Jun. 6, 2024

(54) Reversing Valve, and Assembly Method of Reversing Valve

(71) Applicant: ZHEJIANG DUNAN ARTIFICIAL ENVIRONMENT CO., LTD., Shaoxing, Zhejiang (CN)

(72) Inventors: Zhongbo FENG, Shaoxing, Zhejiang (CN); Fei ZHANG, Shaoxing, Zhejiang (CN); Feilong DU, Shaoxing, Zhejiang (CN)

(21) Appl. No.: 18/279,400

(22) PCT Filed: Feb. 25, 2022
(86) PCT No.: PCT/CN2022/078024

§ 371 Date: Aug. 30, 2023

(30) Foreign Application Priority Data
Mar. 1, 2021 (CN) 202110225462.3
Mar. 1, 2021 (CN) 202120441908.1

(51) Int. Cl. F16K 11/07; F16K 27/10

(52) U.S. Cl. CPC F16K 11/07; F16K 27/10

(57) ABSTRACT

A reversing valve, and an assembly method of the reversing valve. The reversing valve includes: a main valve including a first valve body and an adapter tube, the first valve body having a first valve cavity, and one end of the adapter tube being in communication with the first valve cavity; a pilot valve including a second valve body and a capillary tube, the second valve body having a second valve cavity, a first end of the capillary tube being in communication with the adapter tube or the first valve cavity, and a second end of the capillary tube being in communication with the second valve cavity; and a sleeve, wherein a side wall of the adapter tube is provided with a first mounting hole in communication with an inner hole of the adapter tube; the first valve body is provided with a second mounting hole in communication with the first valve cavity; the sleeve passes through the first mounting hole or the second mounting hole; and the first end of the capillary tube passes through the sleeve.

### CROSS-REFERENCE TO RELATED APPLICATION

The disclosure claims priority to the following patent applications.
1. Priority to Patent Application No. 202110225462.3, filed to the China National Intellectual Property Administration on Mar. 1, 2021 and entitled “Reversing Valve, and Assembly Method of Reversing Valve”.
2. Priority to Patent Application No. 202120441908.1, filed to the China National Intellectual Property Administration on Mar. 1, 2021 and entitled “Reversing Valve”.

### TECHNICAL FIELD

The disclosure relates to a technical field of reversing valves, and in particular to a reversing valve, and an assembly method of the reversing valve.

### BACKGROUND

A four-way valve includes a main valve and a pilot valve. A capillary tube D of the pilot valve is connected with an adapter tube D of the main valve, a capillary tube S of the pilot valve is connected with an adapter tube S of the main valve, and a capillary tube E and a capillary tube C of the pilot valve are in communication with a valve cavity of the main valve respectively, so that a working state of the main valve is switched by the pilot valve.

In related technologies, the capillary tube of the pilot valve is directly connected with the main valve after passing through the main valve, which is convenient to assemble.

### SUMMARY

The disclosure provides a reversing valve, and an assembly method of the reversing valve, so as to solve the problem that a capillary tube of a pilot valve is inconvenient to assemble with a main valve in related technologies.

According to an aspect of the disclosure, a reversing valve is provided. The reversing valve includes: a main valve including a first valve body and an adapter tube, the first valve body having a first valve cavity, and an end of the adapter tube being in communication with the first valve cavity; a pilot valve including a second valve body and a capillary tube, the second valve body having a second valve cavity, a first end of the capillary tube being in communication with the adapter tube or the first valve cavity, and a second end of the capillary tube being in communication with the second valve cavity; and a sleeve. A side wall of the adapter tube is provided with a first mounting hole in communication with an inner hole of the adapter tube. The first valve body is provided with a second mounting hole in communication with the first valve cavity. The sleeve passes through the first mounting hole or the second mounting hole. The first end of the capillary tube passes through the sleeve.

By applying the technical solution of the disclosure, the reversing valve includes the main valve, the pilot valve, and the sleeve. When assembling the capillary tube of the pilot valve with the main valve, firstly, the sleeve passes through the first mounting hole of the adapter tube or the second mounting hole of the first valve body. After completing a connection between the sleeve and the adapter tube or the first valve body, the first end of the capillary tube passes through the sleeve, and finally the capillary tube is connected with the sleeve to complete the assembly of the capillary tube and the main valve. Transition with the sleeve is convenient to assemble the capillary tube, which improves the assembly efficiency.

Further, the material of the adapter tube is different from the material of the sleeve, and the material of the sleeve is the same as the material of the capillary tube. Transition with the sleeve is easier to operate than a way of directly connecting the capillary tube to the adapter tube.

Further, the sleeve is welded to the adapter tube by a tunnel furnace; and/or, the sleeve is made of copper, and the adapter tube is made of steel. After completing the connection between the sleeve and the adapter tube, the capillary tube is inserted into the sleeve, and the capillary tube is welded to the sleeve to complete the connection between the capillary tube and the adapter tube, which is convenient to assemble.

Further, the capillary tube includes a main body section and a reducing section. The reducing section is located at the first end of the capillary tube and passes through the sleeve, and the outer diameter of the main body section is greater than the aperture of the sleeve. After the reducing section is inserted into the sleeve, because the outer diameter of the main body section is greater than the aperture of the sleeve, the main body section restricts the continued insertion of the capillary tube into the sleeve. The insertion depth of the capillary tube into the sleeve is controlled by controlling the length of the reducing section.

Further, the adapter tube includes an inlet tube, an outlet tube, and a low pressure tube. The capillary tube includes a first capillary tube and a second capillary tube. Both ends of the first capillary tube are in communication with the first valve cavity and the second valve cavity respectively, a first end of the second capillary tube is in communication with the inlet tube or the low pressure tube, and a second end of the second capillary tube is in communication with the second valve cavity. A working state of the main valve is controlled by the pilot valve.

Further, an end of the reducing section of the second capillary tube protrudes from an inner wall face of the adapter tube, an interval between the end of the reducing section and the inner wall face of the adapter tube is L, and 1 mm≤L≤3.5 mm. The interval L is set in the above range, which avoids refrigerant throttling while ensuring a stable connection of the second capillary tube. If the interval L is less than 1 mm, the stable connection of the second capillary tube cannot be ensured, and solder is easy to enter the second capillary tube. If the interval is greater than 3.5 mm, the insertion depth of the second capillary tube into the adapter tube is too deep, which results in refrigerant throttling, and then produces abnormal sound.

Further, the end of the reducing section of the first capillary tube is located outside the inner wall face of the first valve body, or the end of the reducing section of the first capillary tube is flush with the inner wall face of the first valve body. Moving parts are arranged in the first valve cavity of the first valve body. The above structure avoids the reducing section of the first capillary tube from interfering in the movement of the moving parts, thereby ensuring the normal operation of an apparatus.

Further, in a case where the sleeve passes through the second mounting hole, an outer wall of the first valve body is provided with a ring flanging, the ring flanging is arranged around the periphery of the second mounting hole, and the sleeve passes through the ring flanging. The sleeve is reinforced by the ring flanging, so that the firmness of a connection between the sleeve and the first valve body is ensured, and the firmness of a connection between the first capillary tube and the sleeve is ensured.

Further, the main body section has a first through hole, the reducing section has a second through hole, the first through hole is in communication with the second through hole, and the aperture of the first through hole is equal to that of the second through hole. Because the aperture of the reducing section is the same as the aperture of the main body section, and the aperture of the reducing section is not reduced, so that the fluid resistance is not increased, and the reducing section does not throttle a refrigerant.

Further, the capillary tube further includes a transition section. One end of the transition section is connected with the main body section, the other end of the transition section is connected withthe reducing section, and the outer diameter of the transition section gradually increases in a direction towards the main body section. The transition section is arranged, so that the reducing section is machined conveniently.

Further, an outer wall of the transition section is an inclined plane or a curved surface.

Further, the transition section is located outside an orifice of the sleeve. When the reducing section is inserted in place, the transition section abuts against the orifice of the sleeve to restrict the continued insertion of the capillary tube.

Further, a welding gap is arranged between an outer wall of the reducing section and a hole wall of the sleeve. When the reducing section is welded with the sleeve, the welding gap is filled with the solder to complete a fixed connection between the capillary tube and the sleeve.

Further, the reversing valve includes a four-way valve.

According to another aspect of the disclosure, an assembly method of the reversing valve is provided. The assembly method of the reversing valve is configured to assemble the provided reversing valve. The assembly method of the reversing valve includes: S1, enabling a sleeve to pass through a first mounting hole or a second mounting hole; S2, tightly assembling an outer wall of the sleeve with a hole wall of the first mounting hole or the second mounting hole by using a fixture; S3, welding the sleeve to an adapter tube or a first valve body by using a tunnel furnace; and S4, enabling a capillary tube to pass through the sleeve, and when the capillary tube passes to a preset position, welding the capillary tube to the sleeve. Transition with the sleeve is convenient to assemble the capillary tube, which improves the assembly efficiency.

### BRIEF DESCRIPTION OF THE DRAWINGS

The accompanying drawings of the specification, which constitute a part of the disclosure, are intended to provide a further understanding of the disclosure, and the exemplary embodiments of the disclosure and the description thereof are intended to explain the disclosure and do not constitute an undue limitation on the disclosure. In the accompanying drawings:

FIG. 1 shows a schematic structural diagram of a reversing valve according to an embodiment of the disclosure.

FIG. 2 shows a local enlarged diagram at a place A in FIG. 1.

FIG. 3 shows a schematic structural diagram of a reversing valve according to an embodiment of the disclosure.

FIG. 4 shows a schematic structural diagram of a main valve in FIG. 1.

Herein, the above accompanying drawings include the following reference signs:

10: Main valve; 11: First valve body; 12: Adapter tube; 121: Inlet tube; 122: Outlet tube; 123: Low pressure tube; 20: Pilot valve; 21: Second valve body; 22: Capillary tube; 221: Main body section; 222:Reducing section; 223:First capillary tube; 224:Second capillary tube; 30:Sleeve; and L: Interval between end of reducing section and inner wall face of adapter tube.

### DETAILED DESCRIPTION OF THE EMBODIMENTS

The technical solutions in the embodiments of the disclosure will be clearly and completely described in conjunction with the drawings in the embodiments of the disclosure. It is apparent that the described embodiments are only a part of the embodiments of the disclosure, and not all of them. The following description of at least one exemplary embodiment is only illustrative, and in no way serves as any limitation on the disclosure or application or use thereof. All other embodiments obtained by those of ordinary skill in the art based on the embodiments of the disclosure without creative efforts are within the scope of the disclosure.

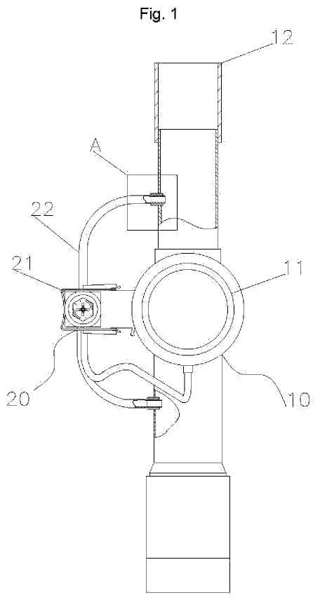

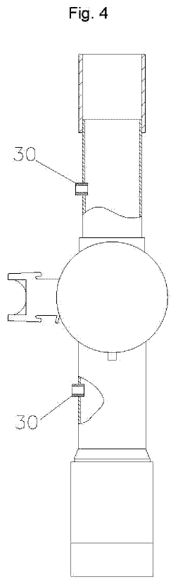

As shown in FIGS. 1 to 4, embodiments of the disclosure provide a reversing valve. The reversing valve includes a main valve 10, a pilot valve 20, and a sleeve 30. The main valve 10 includes a first valve body 11 and an adapter tube 12, the first valve body 11 having a first valve cavity, and an end of the adapter tube 12 being in communication with the first valve cavity. The pilot valve 20 includes a second valve body 21 and a capillary tube 22, the second valve body 21 having a second valve cavity, a first end of the capillary tube 22 being in communication with the adapter tube 12 or the first valve cavity, and a second end of the capillary tube 22 being in communication with the second valve cavity. In the embodiment, a side wall of the adapter tube 12 is provided with a first mounting hole in communication with an inner hole of the adapter tube 12. The first valve body 11 is provided with a second mounting hole in communication with the first valve cavity. The sleeve 30 passes through the first mounting hole or the second mounting hole. The first end of the capillary tube 22 passes through the sleeve 30, so that the first end of the capillary tube 22 is in communication with the adapter tube 12 or the first valve cavity.

By applying the reversing valve provided in the embodiment, when assembling the capillary tube 22 of the pilot valve 20 with the main valve 10, firstly, the sleeve 30 passes through the first mounting hole of the adapter tube 12 or the second mounting hole of the first valve body 11. After completing a connection between the sleeve 30 and the adapter tube 12 or the first valve body 11, the first end of the capillary tube 22 passes through the sleeve 30, and finally the capillary tube 22 is connected with the sleeve 30 to complete the assembly of the capillary tube 22 and the main valve 10. Transition with the sleeve 30 is convenient to assemble the capillary tube 22, which improves the assembly efficiency.

It is to be noted that an end of the adapter tube 12 is in communication with the first valve cavity 11, which means that an end of the adapter tube 12 is connected with the first valve body 11, and the end of the adapter tube 12 passes through a side wall of the first valve body 11 and is in communication with the first valve cavity.

Further, the material of the adapter tube 12 is different from the material of the sleeve 30, and the material of the sleeve 30 is the same as the material of the capillary tube 22. Transition with the sleeve 30 is easier to operate than a way of directly connecting the capillary tube 22 to the adapter tube 12.

In the embodiment, the sleeve 30 is made of copper, the adapter tube 12 is made of steel, and the sleeve 30 is welded with the adapter tube 12 by a tunnel furnace. After completing the connection between the sleeve 30 and the adapter tube 12, the capillary tube 22 is inserted into the sleeve 30, and the capillary tube 22 is welded with the sleeve 30 to complete the connection between the capillary tube 22 and the adapter tube 12, which is convenient to assemble.

Specifically, the adapter tube 12 is made of stainless steel, and the sleeve 30 is made of red copper.

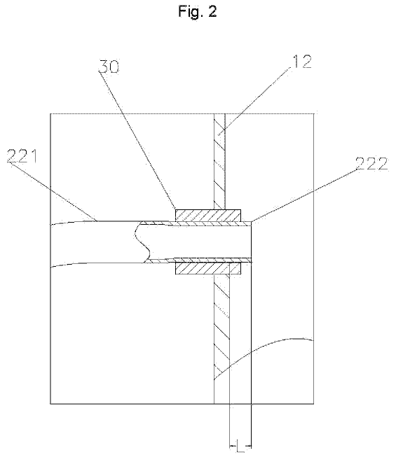

As shown in FIG. 2, the capillary tube 22 includes a main body section 221 and a reducing section 222. The reducing section 222 is located at the first end of the capillary tube 22 and passes through the sleeve 30, and the outer diameter of the main body section 221 is greater than the aperture of the sleeve 30. After the reducing section 222 is inserted into the sleeve 30, because the outer diameter of the main body section 221 is greater than the aperture of the sleeve 30, the main body section 221 restricts the continued insertion of the capillary tube 22 into the sleeve 30. The insertion depth of the capillary tube 22 into the sleeve 30 is controlled by controlling the length of the reducing section 222.

When the sleeve 30 is assembled to the adapter tube 12 or the first valve body 11, the insertion depth of the sleeve 30 is controlled by a fixture, and in combination with the structure of the reducing section 222, the insertion depth of the capillary tube 22 into the adapter tube 12 or the first valve body 11 is restricted.

It is to be noted that if the insertion depth of the capillary tube of the pilot valve into the adapter tube is too deep, during the use of an air conditioner, when a refrigerant flows through the section of the adapter tube, refrigerant throttling is generated, and then abnormal sound is produced, thereby affecting the user experience. In the embodiment, the sleeve 30 is matched with the reducing section 222 to restrict the insertion depth of the capillary tube 22 into the adapter tube 12, which avoids refrigerant throttling, prevents abnormal sound, and improves the user experience.

A way of arranging the reducing section 222 at the first end of the capillary tube 22 has the advantages of being simple in structure and convenient to machine, and reduces the machining cost and assembly cost.

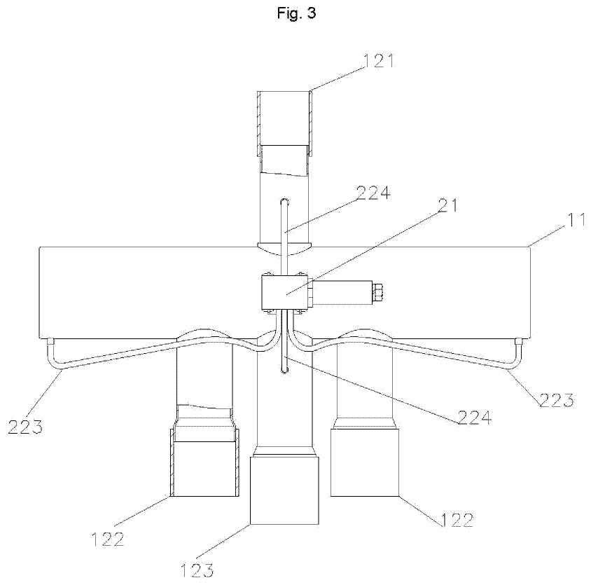

As shown in FIG. 3, in the embodiment, the adapter tube 12 includes an inlet tube 121, an outlet tube 122, and a low pressure tube 123. The capillary tube 22 includes a first capillary tube 223 and a second capillary tube 224. Both ends of the first capillary tube 223 are in communication with the first valve cavity and the second valve cavity respectively, a first end of the second capillary tube 224 is in communication with the inlet tube 121 or the low pressure tube 123, and a second end of the second capillary tube 224 is in communication with the second valve cavity. A working state of the main valve 10 is controlled by the pilot valve 20.

As shown in FIG. 2, an end of the reducing section 222 of the second capillary tube 224 protrudes from an inner wall face of the adapter tube 12, an interval between the end of the reducing section 222 and the inner wall face of the adapter tube 12 is L, and 1 mm≤L≤3.5 mm. The interval L is set in the above range, which avoids refrigerant throttling while ensuring a stable connection of the second capillary tube 224. If the interval L is less than 1 mm, the stable connection of the second capillary tube 224 cannot be ensured, and solder is easy to enter the second capillary tube 224. If the interval is greater than 3.5 mm, the insertion depth of the second capillary tube 224 into the adapter tube 12 is too deep, which results in refrigerant throttling, and then produces abnormal sound.

In the embodiment, the end of the sleeve 30 protrudes from the inner wall face of the adapter tube 12, and the end of the reducing section 222 of the second capillary tube 224 protrudes from the end of the sleeve 30.

It is to be noted that the end of the reducing section 222 protrudes from the inner wall face of the adapter tube 12, which means that a distance between the end of the reducing section 222 and an axis of the adapter tube 12 is less than a distance between the inner wall face of the adapter tube 12 and the axis of the adapter tube 12.

In the embodiment, the end of the reducing section 222 of the first capillary tube 223 is located outside the inner wall face of the first valve body 11, or the end of the reducing section 222 of the first capillary tube 223 is flush with the inner wall face of the first valve body 11. Moving parts are arranged in the first valve cavity of the first valve body 11. The above structure avoids the reducing section 222 of the first capillary tube 223 from interfering in the movement of the moving parts, thereby ensuring the normal operation of an apparatus

In order to ensure the connection strength between the sleeve 30 and the first valve body 11, in a case where the sleeve 30 passes through the second mounting hole, an outer wall of the first valve body 11 is provided with a ring flanging, the ring flanging is arranged around the periphery of the second mounting hole, and the sleeve 30 passes through the ring flanging.

Because the end of the reducing section 222 of the first capillary tube 223 is located outside the inner wall face of the first valve body 11, or the end of the reducing section 222 of the first capillary tube 223 is flush with the inner wall face of the first valve body 11, the sleeve 30 is reinforced by the ring flanging, so that the firmness of a connection between the sleeve 30 and the first valve body 11 is ensured, and the firmness of a connection between the first capillary tube 223 and the sleeve 30 is ensured.

The main body section 221 has a first through hole, the reducing section 222 has a second through hole, the first through hole is in communication with the second through hole, and the aperture of the first through hole is equal to the aperture of the second through hole. Because the aperture of the reducing section 222 is the same as the aperture of the main body section 221, and the aperture of the reducing section 222 is not reduced, so that the fluid resistance is not increased, and the reducing section 222 does not throttle a refrigerant.

Specifically, the outer diameter of the main section 221 is greater than the outer diameter of the reducing section 222, and the inner diameter of the main section 221 is equal to that of the reducing section 222.

In the embodiment, a welding gap is arranged between an outer wall of the reducing section 222 and a hole wall of the sleeve 30. When the reducing section 222 is welded with the sleeve 30, the welding gap is filled with the solder to complete a fixed connection between the capillary tube 22 and the sleeve 30.

The capillary tube 22 further includes a transition section. One end of the transition section is connected with the main body section 221, the other end of the transition section is connected with the reducing section 222, and the outer diameter of the transition section gradually increases in a direction towards the main body section 221. The transition section is arranged, so that the reducing section 222 is machined conveniently. An outer wall of the transition section may be an inclined plane, and the structure is simple. Or, the outer wall of the transition section may be arranged as a curved surface.

Specifically, the transition section is located outside an orifice of the sleeve 30. When the reducing section 222 is inserted in place, the transition section abuts against the orifice of the sleeve 30 to restrict the continued insertion of the capillary tube 22.

In the embodiment, the reversing valve includes a four-way valve.

In the embodiment, the adapter tube 12 includes two outlet tubes 122. The low pressure tube 123 is located between the two outlet tubes 122.

Another embodiment of the disclosure provides an assembly method of a reversing valve. The assembly method of a reversing valve is configured to assemble the above provided reversing valve. The assembly method of the reversing valve includes the following operations.

At S1, a sleeve 30 passes through a first mounting hole or a second mounting hole.

At S2, an outer wall of the sleeve 30 is tightly assembled with a hole wall of the first mounting hole or the second mounting hole by using a fixture.

At S3, the sleeve 30 is welded to the adapter tube 12 or the first valve body 11 by using a tunnel furnace.

At S4, a capillary tube 22 passes through the sleeve 30, and when the capillary tube 22 passes to a preset position, the capillary tube 22 is welded to the sleeve 30.

In S2, the operation that the outer wall of the sleeve 30 is tightly assembled with the hole wall of the first mounting hole or the second mounting hole by using the fixture specifically includes that: in a case where the sleeve 30 passes through the first mounting hole or the second mounting hole, the fixture passes through an inner hole of the sleeve 30, and the sleeve 30 is flared by the fixture, so that the outer wall of the sleeve 30 is tightly supported on the hole wall of the first mounting hole or the second mounting hole to achieve the prefixation of the sleeve 30.

The fixture is completed from inside the adapter tube 12 to the outside without destroying the caliber of an insertion port of the capillary tube.

In S4, the operation that when the capillary tube 22 passes to the preset position, the capillary tube 22 is welded to the sleeve 30 specifically includes that: after the reducing section 222 of the capillary tube 22 is inserted into the sleeve 30, as the reducing section 222 deeps, when the main body section 221 abuts against a mouth of the sleeve 30, the main body section 221 restricts the continued insertion of the capillary tube 22 into the sleeve 30, at this time, the capillary tube 22 passes to the preset position, and then the assembly is immediately completed by welding the capillary tube 22 to the sleeve 30.

The above are only the preferred embodiments of the disclosure, and is not intended to limit the disclosure, and for those of ordinary skill in the art, various modifications and changes can be made to the disclosure. Any modifications, equivalent substitutions, improvements, etc. within the spirit and scope of the disclosure shall be included in the scope of protection of the disclosure.

What is claimed is:

1. A reversing valve, comprising:
a main valve comprising a first valve body and an adapter tube, the first valve body having a first valve cavity, and an end of the adapter tube being in communication with the first valve cavity;
a pilot valve comprising a second valve body and a capillary tube, the second valve body having a second valve cavity, a first end of the capillary tube being in communication with the adapter tube or the first valve cavity, and a second end of the capillary tube being in communication with the second valve cavity; and
a sleeve, wherein a side wall of the adapter tube is provided with a first mounting hole in communication with an inner hole of the adapter tube; the first valve body is provided with a second mounting hole in communication with the first valve cavity; the sleeve passes through the first mounting hole or the second mounting hole; and the first end of the capillary tube passes through the sleeve.

2. The reversing valve according to claim 1, wherein a material of the adapter tube is different from a material of the sleeve, and the material of the sleeve is the same as a material of the capillary tube.

3. The reversing valve according to claim 1, wherein,
the sleeve is welded to the adapter tube by a tunnel furnace; and/or,
the sleeve is made of copper, and the adapter tube is made of steel.

4. The reversing valve according to claim 1, wherein the capillary tube comprises a main body section and a reducing section, wherein the reducing section is located at the first end of the capillary tube and passes through the sleeve, and an outer diameter of the main body section is greater than an aperture of the sleeve.

5. The reversing valve according to claim 4, wherein the adapter tube comprises an inlet tube, an outlet tube, and a low pressure tube; the capillary tube comprises a first capillary tube and a second capillary tube, wherein both ends of the first capillary tube are in communication with the first valve cavity and the second valve cavity respectively, a first end of the second capillary tube is in communication with the inlet tube or the low pressure tube, and a second end of the second capillary tube is in communication with the second valve cavity.

6. The reversing valve according to claim 5, wherein an end of the reducing section of the second capillary tube protrudes from an inner wall face of the adapter tube, an interval between the end of the reducing section and the inner wall face of the adapter tube is L, and 1 mm≤L≤3.5 mm.

7. The reversing valve according to claim 5, wherein an end of the reducing section of the first capillary tube is located outside an inner wall face of the first valve body, or the end of the reducing section of the first capillary tube is flush with the inner wall face of the first valve body.

8. The reversing valve according to claim 1, wherein in a case where the sleeve passes through the second mounting hole, an outer wall of the first valve body is provided with a ring flanging, the ring flanging is arranged around a periphery of the second mounting hole, and the sleeve passes through the ring flanging.

9. The reversing valve according to claim 4, wherein the main body section has a first through hole, the reducing section has a second through hole, the first through hole is in communication with the second through hole, and an aperture of the first through hole is equal to an aperture of the second through hole.

10. The reversing valve according to claim 4, wherein the capillary tube further comprises a transition section, wherein one end of the transition section is connected with the main body section, the other end of the transition section is connected with the reducing section, and an outer diameter of the transition section gradually increases in a direction towards the main body section.

11. The reversing valve according to claim 10, wherein an outer wall of the transition section is an inclined plane or a curved surface.

12. The reversing valve according to claim 10, wherein the transition section is located outside an orifice of the sleeve.

13. The reversing valve according to claim 4, wherein a welding gap is arranged between an outer wall of the reducing section and a hole wall of the sleeve.

14. The reversing valve according to claim 1, comprising a four-way valve.

15. An assembly method of a reversing valve, wherein the assembly method of the reversing valve is configured to assemble the reversing valve according to claim 1, and the assembly method of the reversing valve comprises:
S1, enabling a sleeve to pass through a first mounting hole or a second mounting hole;
S2, tightly assembling an outer wall of the sleeve with a hole wall of the first mounting hole or the second mounting hole by using a fixture;
S3, welding the sleeve to an adapter tube or a first valve body by using a tunnel furnace; and
S4, enabling a capillary tube to pass through the sleeve, and when the capillary tube passes to a preset position, welding the capillary tube to the sleeve.

16. The reversing valve according to claim 2, wherein the capillary tube comprises a main body section and a reducing section, wherein the reducing section is located at the first end of the capillary tube and passes through the sleeve, and an outer diameter of the main body section is greater than an aperture of the sleeve.

17. The reversing valve according to claim 3, wherein the capillary tube comprises a main body section and a reducing section, wherein the reducing section is located at the first end of the capillary tube and passes through the sleeve, and an outer diameter of the main body section is greater than an aperture of the sleeve.

18. The assembly method of the reversing valve according to claim 15, wherein a material of the adapter tube is different from a material of the sleeve, and the material of the sleeve is the same as a material of the capillary tube.

19. The assembly method of the reversing valve according to claim 15, wherein,
the sleeve is welded to the adapter tube by a tunnel furnace; and/or,
the sleeve is made of copper, and the adapter tube is made of steel.

20. The assembly method of the reversing valve according to claim 15, wherein the capillary tube comprises a main body section and a reducing section, wherein the reducing section is located at the first end of the capillary tube and passes through the sleeve, and an outer diameter of the main body section is greater than an aperture of the sleeve.
